(19) United States
(12) Patent Application Publication
(10) Pub. No.: US 2025/0376965 A1
(43) Pub. Date: Dec. 11, 2025

(54) Closed Crankcase Ventilation System and Internal Combustion Engine

(71) Applicant: DAF Trucks N.V., Eindhoven (NL)

(72) Inventors: John De Graaf, Eindhoven (NL); Satish IGADE, Eindhoven (NL); Abhisek PRADHAN, Eindhoven (NL)

(21) Appl. No.: 19/207,771

(22) Filed: May 14, 2025

(30) Foreign Application Priority Data
Jun. 7, 2024 (NL) 2037890

(51) Int. Cl. F02M 25/06; F01M 13/00; F01M 13/04

(52) U.S. Cl. CPC F02M 25/06; F01M 13/04; F01M 2013/0083; F01M 2013/0438

(57) ABSTRACT

A closed crankcase ventilation system for removing blow-by gases, leaking from a combustion chamber, from a crankcase of an internal combustion engine. The system comprises a blow-by line extending between the crankcase and an air intake line of the internal combustion engine. When the engine is running, the air intake line provides a vacuum source for drawing blow-by gases from the crankcase through the blow-by line. A crankcase depression regulator is arranged in the blow-by line for regulating a level of vacuum inside the crankcase. At least one pressure sensor is arranged for measuring a pressure in the blow-by line relative to atmospheric pressure. A control unit is arranged for detecting leakages in the blow-by line by performing a diagnostic test based on a pressure measurement signal from a single pressure sensor.

The invention relates to a closed crankcase ventilation (CCV) system for removing blow-by gases, leaking from a combustion chamber, from a crankcase of an internal combustion engine. The invention further relates to an internal combustion engine comprising such a closed crankcase ventilation system.

Worldwide trend shows government regulations setting up new limits for exhaust emissions from IC engines. Emission limits continue to reduce and are expected to approach near zero limits. To meet these stringent norms, besides improving exhaust gas emission system, the crankcase ventilation system may also need improvements.

Blow-by is created when the air-fuel mixture and combustion gases leak past the engine's piston rings. The pressurized air-fuel mixture and combustion gases leak into the engine's crankcase through small gaps between the piston rings and cylinder walls. The resulting mixture of gases, lubrication oil mist, and other contaminants is called blow-by. Crankcase ventilation is the process of venting or removing blow-by from an engine's crankcase to prevent excessive pressure build-up within the engine. A crankcase ventilation filter may be installed to clean the vented gases before returning to the engine's intake or discharging to the environment.

In traditional open crankcase ventilation (OCV) systems, the filtered crankcase blow-by gases are released into the atmosphere and hence contribute to the emissions produced by the engine.

In contrast, closed crankcase ventilation (CCV) systems, do not directly release the crankcase blow-by gases into the atmosphere. Instead, the filtered crankcase blow-by gas is fed back into the air intake system of the engine, where it is mixed with the intake air and re-entered into the cylinder. In this way, CCV technology can significantly reduce the emissions caused by crankcase blow-by gas.

Because proper functioning of the CCV system is critical for the amount of emissions, it may be necessary to regularly diagnose and service the CCV system. For example, non-integral parts may gradually become loose or may be forgotten to be properly fixated again after disassembly, and leakages may occur.

It is a challenge to diagnose a CCV system in an accurate and reliable fashion.

### SUMMARY

It is therefore an object of the present invention to improve the reliability and accuracy of CCV system diagnostic tests. Aspects of the invention relate to a closed crankcase ventilation system as defined in the appended claims, for removing blow-by gases leaking from a combustion chamber from a crankcase of an internal combustion engine.

The system comprises a blow-by line that extends between the crankcase and an air intake line of the internal combustion engine. When the internal combustion engine is running, the air intake line provides a vacuum source for drawing blow-by gases from the crankcase through the blow-by line.

A crankcase depression regulator of the system is arranged in the blow-by line for regulating a level of vacuum inside the crankcase.

One or more pressure sensors of the system are each arranged for measuring a pressure in the blow-by line relative to atmospheric pressure.

The system comprises a control unit that is arranged for detecting leakages in the blow-by line by performing a diagnostic test by: (i) receiving, within a diagnostic time period, a pressure measurement signal from each of the one or more pressure sensors; (ii) calculating, for each received pressure measurement signal, a difference between an absolute maximum and an absolute minimum of the received pressure measurement signal to define a delta pressure; (iii) calculating, for each received pressure measurement signal, an average pressure of the received pressure measurement signal over the diagnostic time period; and (iv) generating an alert signal indicative of a leakage in the blow-by line in response to determining that for at least one of the received pressure measurement signals, the following conditions are both true:
the delta pressure is lower than a first threshold; and
the average pressure is higher than a second threshold.

Hence, in case at least one of the above criteria is not met, the control unit does not generate the alert signal, but may instead generate a pass signal indicative of a healthy, non-leaking, CCV system, and continue with a further, subsequent diagnostic test.

In accordance with the present invention, the diagnostic test is performed based on a pressure measurement signal from a single pressure sensor, e.g. a gauge pressure sensor, that is arranged for measuring a pressure in the blow-by line relative to atmospheric pressure. In other words, the diagnostic test is not based on a differential pressure measurement in which the difference between the outputs of two pressure sensors is taken. Instead, the system of the present invention determines whether or not a leakage is present in the blow-by line by taking a sample of the pressure measurement signal that is produced by a single pressure sensor during a diagnostic time period with a predefined time length, and subsequently analyzing the single pressure measurement signal from the single pressure sensor, in particular by calculating the height of oscillations of the signal, i.e. the difference between the absolute minimum and the absolute maximum, and by calculating the average pressure of the single pressure measurement signal. By comparing these calculated values to respective calibratable thresholds, an indication of a healthy (e.g. intact) or defective (e.g. leaky) CCV system is obtained.

In contrast, known systems compare at least two pressure measurement signals from sensors placed at different locations in the blow-by line, i.e. forming a differential pressure sensor, in order to detect variations in the pressure drop over a length of the blow-by line, to monitor the functioning of the system. While such known systems may be capable of detecting relatively large defects in the blow-by line, such as a clogged filter or malfunctioning pressure regulator, they are generally less sensitive to small defects and leakages unless more pressure sensors are used over the length of the blow-by line and thus increasing the complexity of the system.

The present invention increases the sensitivity, and thus the accuracy of the diagnostic test without requiring more pressure sensors. Instead, defects and leakages in the blow-by line can be detected using only a single pressure sensor, and processing the corresponding pressure measurement signal as described herein.

Preferably, the controller is arranged for performing the diagnostic test when the engine is running in a steady state, e.g. after the engine is cranked and running idle or delivering drive power. In other words, the diagnostic test is not performed during cranking.

The blow-by line may comprise a first section which extends between the crankcase and the crankcase depression regulator, and a second section which extends between the crankcase depression regulator and the air intake line. In use, a first working pressure in the first section may be different to a second working pressure in the second section. For example, the first working pressure may be larger than the second working pressure, due to the vacuum source formed by the air intake line.

In some embodiments, the at least one pressure sensor may therefore comprise a first pressure sensor provided in the first section of the blow-by line between the crankcase and the crankcase depression regulator. The first pressure sensor may be arranged for measuring a first pressure in the first section, e.g. the first working pressure, relative to atmospheric pressure, and the control unit may be arranged for performing the diagnostic test by receiving the pressure measurement signal from the first pressure sensor. In this way, defects and leakages in the first section can be accurately detected.

In other or further embodiments, the at least one pressure sensor comprises a second pressure sensor, provided in the second section of the blow-by line between the crankcase depression regulator and the intake line and arranged for measuring a second pressure in the second section, e.g. the second working pressure, relative to atmospheric pressure. The control unit may correspondingly be arranged for performing the diagnostic test by receiving the pressure measurement signal from the second pressure sensor. In this way, defects and leakages in the second section can be accurately detected.

During use of the internal combustion engine the operating conditions of the CCV system may vary. For example, the amount of blow-by gases to be removed from the crankcase, as well as the amount of vacuum created by the air intake line, may change in dependence of engine load and speed. In order to take such variations into account, the control unit is preferably arranged for calculating the first threshold and/or the second threshold as function of engine speed and engine torque of the internal combustion engine.

In order to avoid that the diagnostic test is based on faulty or incorrect measurement data, the control unit may comprise a signal processor arranged for processing the pressure measurement signal received from the at least one pressure sensor, and for determining a health status of the at least one pressure sensor by comparing a voltage, current, frequency and/or continuity of the pressure measurement signal relative to a reference. A discrepancy between the reference voltage, current, frequency and/or continuity and an actual voltage, current, frequency and/or continuity of the pressure measurement signal may be indicative of a faulty sensor, potentially reducing the accuracy and/or reliability of the diagnostic test. Accordingly, the control unit may be arranged for aborting the diagnostic test in response to determining that the health status indicates a sensor failure of the at least one pressure sensor.

Optionally, the control unit can be arranged for starting the diagnostic time period in response to determining that one or more of the following enable conditions are met: (i) a filter module in the blow-by line is active; (ii) an ambient temperature is larger than an ambient temperature threshold value; (iii) an engine coolant temperature is larger than an engine coolant temperature threshold value; and (iv) an engine running time is larger than an engine running time threshold value. For example, only when at least one of the enable conditions are met, the control unit starts the diagnostic time period to initiate the diagnostic test. Preferably, at least two of the enable criteria are met, more preferably all of the criteria. Instead of the conditions mentioned above, other conditions may be checked by the control unit before starting the diagnostic test. For example, one or more of the following conditions may be checked before starting the test:

The engine coolant temperature is larger than 60 degrees Celsius;

The pressure sensor supply voltage is between 4.7 V and 5.2 V;

The engine run time is larger than 150 seconds;

The fuel quantity injected in the cylinders is between 10-150 mg for a diagnostic test on the first section of the blow by line, or between 130-270 mg for a diagnostic test on the second section;

The engine speed is between 500-1400 rpm for a diagnostic test on the first section of the blow by line, or between 1200-2200 rpm for a diagnostic test on the second section;

The rotor speed of a rotating crankcase ventilator in the blow-by line is between 8000-14000 rpm.

The abovementioned ranges can be calibrated, e.g. depending on the section of the blow-by line to be monitored with a diagnostic test, and/or depending on engine configuration and operating conditions.

Optimal sensitivity of the diagnostic test can be achieved when the diagnostic time period has a length between 10 and 120 seconds, preferably between 10-30 seconds, or less than 60 seconds. A diagnostic time period shorter than 10 seconds may be too sensitive to pressure fluctuations in the crankcase that are caused by the combustion process, instead of by leakages in the blow-by line. Conversely, when using a diagnostic time period larger than 120 seconds it may take longer, e.g. too long, to determine whether a leakage is present. Preferably, the diagnostic time period is calibratable so that an optimal diagnostic time period can be set, e.g. based on the engine type and configuration, and/or the engine operating conditions. The diagnostic time period may be set by a user or by the control unit. For example, the control unit may be arranged for adapting the diagnostic time period in real-time, or at regular intervals, e.g. based on engine operating conditions.

In some embodiments, the closed crankcase ventilation system further comprises a filter module provided in the blow-by line and arranged for filtering blow-by gas that passes through the filter module. For example, the filter module may comprise a low or high grade coalescing filter, e.g. motor assisted, or a basic breather. Alternatively, or additionally, the filter module may comprise a rotating crankcase ventilator. Such a rotating crankcase ventilator, or centrifugal separator, comprises one or more discs that are rotatably suspended about a common axis inside a housing. In use, blow-by gas is fed into the separator while the discs are rotating, e.g. at a speed of 7,000-9,000 rpm. Oil and soot particles are removed from the blow-by gas by means of centrifugal forces. The droplets and particles coalesce on the discs and form larger clusters which, due to the centrifugal force, move toward the outer edge of the discs, where they are discharged onto the inner wall of the separator housing. The droplets and particles then run down to the bottom of the separator, before finally being discharged, e.g. returned to the engine sump. The control unit can be arranged for controlling the rotation speed of the rotating crankcase ventilator based on the pressure measurement signal. Alternatively, or additionally, the control unit may be arranged for controlling the rotation speed based on an engine speed and/or engine torque of the internal combustion engine.

The crankcase depression regulator may be passive or active. For example, a passive crankcase depression regulator may comprise a throttle, a nozzle, or a pressure relief valve. In some embodiments, the crankcase depression regulator comprises a valve mechanism for narrowing and expanding a passage for blow-by gases through the blow-by line, and a valve actuator for actuating the valve mechanism; wherein the control unit is further arranged for controlling the valve actuator based on the pressure measurement signal.

Other aspects of the present invention relate to an internal combustion engine as defined in the appended claims. The internal combustion engine may be a compression ignition engine e.g. a Diesel engine. The internal combustion engine comprises a closed crankcase ventilation system as described herein.

In some embodiments, the intake line of the internal combustion engine comprises a turbo compressor arranged for pressurizing the intake air, and the blow-by line connects to the intake line upstream the compressor, e.g. between the turbo compressor and an air filter in the intake line, such that blow-by gases enter the air intake line before the turbo compressor. In use, as the compressor is rotating, intake air is drawn into the inlet compressor, thereby creating a low pressure section or vacuum source in the air intake line. Hence, the compressor can provide the vacuum source for drawing blow-by gases from the crankcase.

### BRIEF DESCRIPTION OF THE DRAWINGS

The invention will be further elucidated in the figures:

FIG. 1 illustrates an embodiment of a closed crankcase ventilation (CCV) system of an internal combustion engine;

FIG. 2 illustrates a controller of the CCV system, arranged for performing a diagnostic test;

FIG. 3 illustrates an exemplary graph of a pressure measurement signal from a healthy section of the blow-by line upstream the crankcase depression regulator;

FIG. 4 illustrates an exemplary graph of a pressure measurement signal from a leaking section of the blow-by line upstream the crankcase depression regulator;

FIG. 5 illustrates another or further embodiment of the CCV system, wherein the pressure sensor is arranged downstream the crankcase depression regulator;

FIG. 6 illustrates another or further embodiment of the CCV system, with a first pressure sensor upstream and a second pressure sensor downstream the crankcase depression regulator;

FIG. 7 illustrates an exemplary graph of a pressure measurement signal from a healthy section of the blow-by line downstream the crankcase depression regulator;

FIG. 8 illustrates an exemplary graph of a pressure measurement signal from a leaking section of the blow-by line downstream the crankcase depression regulator;

FIG. 9 illustrates yet another or further embodiment of the CCV system.

### DETAILED DESCRIPTION

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

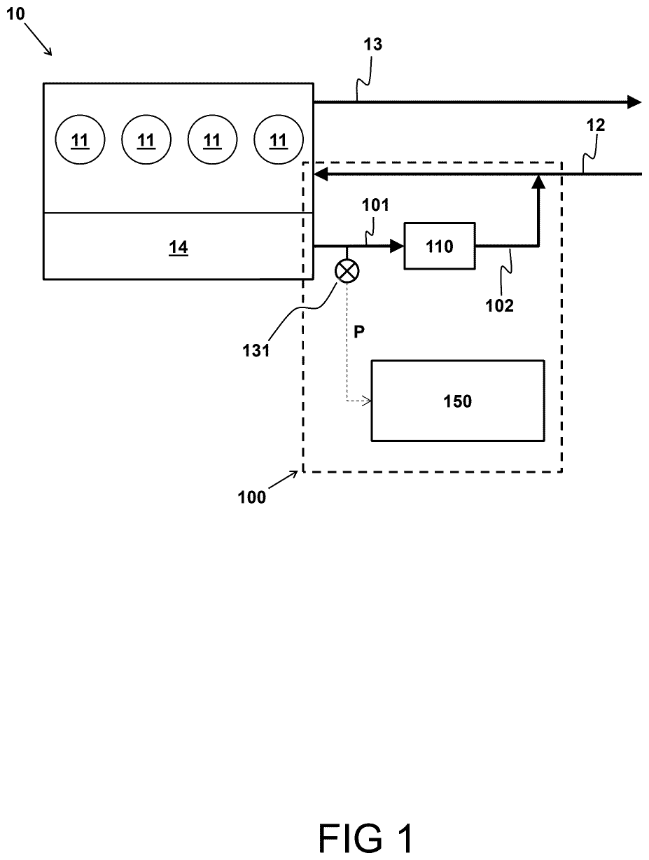

FIG. 1 illustrates an internal combustion engine 10, e.g. a compression ignition engine such as a Diesel engine. The internal combustion engine 10 comprises one or more cylinders 11, an air intake line 12, e.g. comprising an intake manifold, for supplying air to the one or more cylinders 11, and an exhaust line 13, e.g. comprising an exhaust manifold, for discharging exhaust gases from the one or more cylinders 11.

During normal use of the engine 10, blow-by gases leak from the combustion chamber of the cylinders 11, past the pistons, and into the crankcase 14. Such blow-by gases typically comprise a mixture of exhaust gas, lubrication oil mist, and other contaminants, which are accumulated in the crankcase 14. In order to prevent excessive pressure build-up within the engine, the blow-by gases can be removed from the crankcase 14 by means of crankcase ventilation. Instead of ventilating, i.e. discharging, the blow-by gases from the crankcase 14 directly into the atmosphere, thus contributing to engine emissions, blow-by gases can be returned to the intake line 12 by a closed crankcase ventilation, CCV, system 100, as illustrated in FIG. 1.

The CCV system 100 comprises a blow-by line 101, 102 that extends between the crankcase 14 and the air intake line 12. When the internal combustion engine is running, the air intake line 12 provides a vacuum source for drawing blow-by gases from the crankcase 14 through the blow-by line 101, 102. The vacuum formed by the air intake line 12 is an effect of the engine's piston movement drawing air into the cylinder 11 in the intake stroke. This vacuum source is used by the crankcase ventilation system 100 for drawing blow-by gases from the crankcase 14.

A crankcase depression regulator, CDR, 110 is arranged in the blow-by line 101, 102 for regulating the level of vacuum inside the crankcase 14. The purpose of the CDR 110 is to maintain a slight vacuum or depression in the crankcase 14 to help control emissions and prevent the leakage of oil and gases from the crankcase 14. The CDR 110 may be connected to the crankcase 14 through a breather tube or hose that is part of the blow-by line 101, 102. The CDR 110 may contain a diaphragm, throttle or valve mechanism that responds to changes in pressure within the crankcase 14, e.g. by opening and closing a passage for blow-by gases through the blow-by line. The CDR 110 may further comprise a valve actuator for actuating the valve mechanism. When the pressure in the crankcase 14 becomes too high, the CDR 110 may open to allow gases and vapors to be drawn out of the crankcase 14 and into the engine's intake line 12. By thus controlling the pressure in the crankcase 14 and directing gases and vapors back into the engine for combustion, the CCV system 100 helps to reduce harmful emissions from the engine.

A pressure sensor 131, e.g. gauge pressure sensor or absolute pressure sensor, is arranged for measuring a pressure P in the blow-by line 101, 102 relative to atmospheric pressure. The pressure sensor 131 can be provided in a section of the blow-by line upstream 101 or downstream 102 the CDR 110.

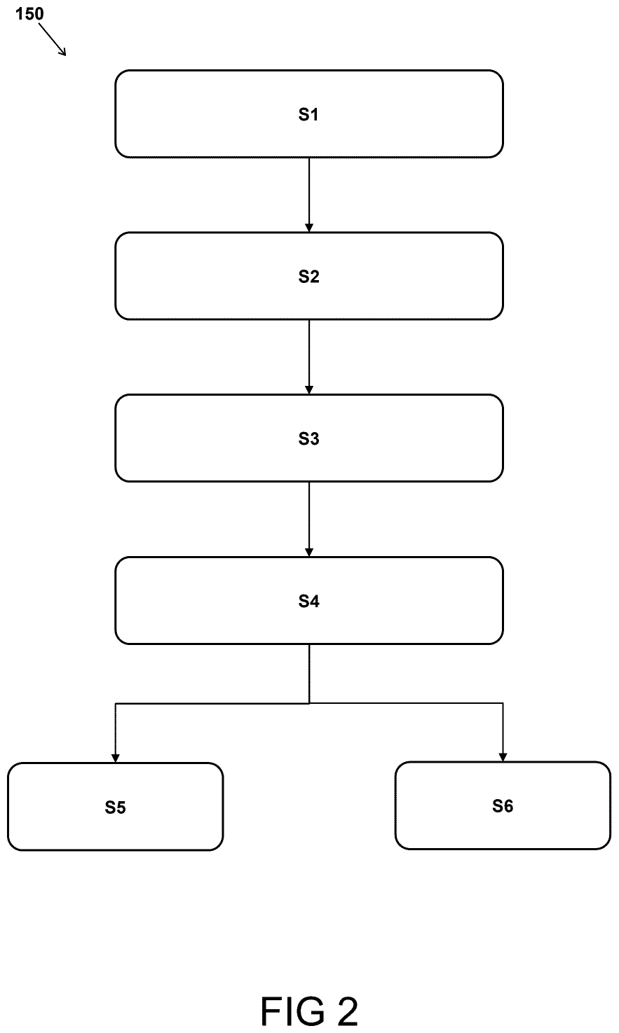

A control unit 150 is arranged for detecting a leakage in the blow-by line 101, 102 by performing a diagnostic test based on a pressure measurement signal P from the pressure sensor 131. An embodiment of the diagnostic test is illustrated in FIG. 2.

In a first step S1 of the diagnostic test, the control unit 150 receives the pressure measurement signal P from the single pressure sensor 131 within a predefined diagnostic time period. The pressure measurement signal P that is received during the diagnostic time period is analyzed by the control unit 150 as an independent set of measurement data. After expiry of the diagnostic time period, a further diagnostic period may be started in which a further pressure measurement signal is received. The length of the diagnostic time period can be optimized such that the set includes sufficient data points to obtain a reliable outcome, while allowing subsequent data sets to be analyzed at an acceptable frequency. Accordingly, the diagnostic time period may have a length between 10 and 120 seconds, preferably less than 60 seconds, e.g. between 10 and 30 seconds. In some cases, a diagnostic time period with a length of about 20 seconds is found to provide optimal results.

After expiry of the diagnostic time period, the control unit 150 analyzes the received pressure measurement signal and determines, in a second step S2, an absolute maximum and an absolute minimum of the signal. The control unit calculates the difference between the absolute maximum and minimum to define a delta pressure. Furthermore, in a third step S3, the control unit 150 calculates an average pressure of the received pressure measurement signal over the diagnostic time period.

In a fourth step S4, the control unit 150 determines whether the delta pressure is lower than a first threshold value and whether the average pressure is higher than a second threshold value. In case both these conditions are true, the control unit 150 generates, in step S5, an alert signal indicative of a leakage in the blow-by line. The first and second threshold values are calibratable, as they may be dependent on engine type, geometry and configuration of the CCV system, and of the actual engine operating conditions.

In case no leakage is detected, i.e. in that at least one of the abovementioned conditions is not true, the controller 150 does not generate an alert signal, and may proceed by performing a new, subsequent diagnostic test, by receiving a further pressure measurement signal during a further diagnostic time period, and analyzing the further pressure measurement signal in step S6 as illustrated in FIG. 2.

The first threshold and/or the second threshold may be dependent on the type and size of the internal combustion engine, and the expected range of pressures that would occur in the blow-by line during normal use. The control unit 150 may be arranged to adapt the first and/or second threshold based on input(s) from the internal combustion engine 10. For example, the control unit 15 may adapt the first and/or second threshold as function of actual engine speed or engine torque of the internal combustion engine, or of a measured ambient atmospheric pressure or temperature.

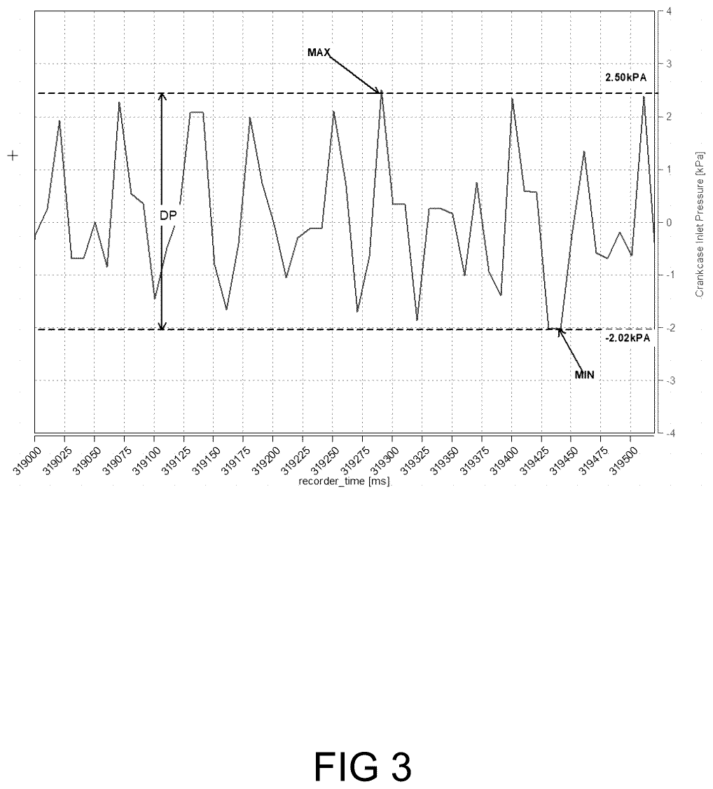

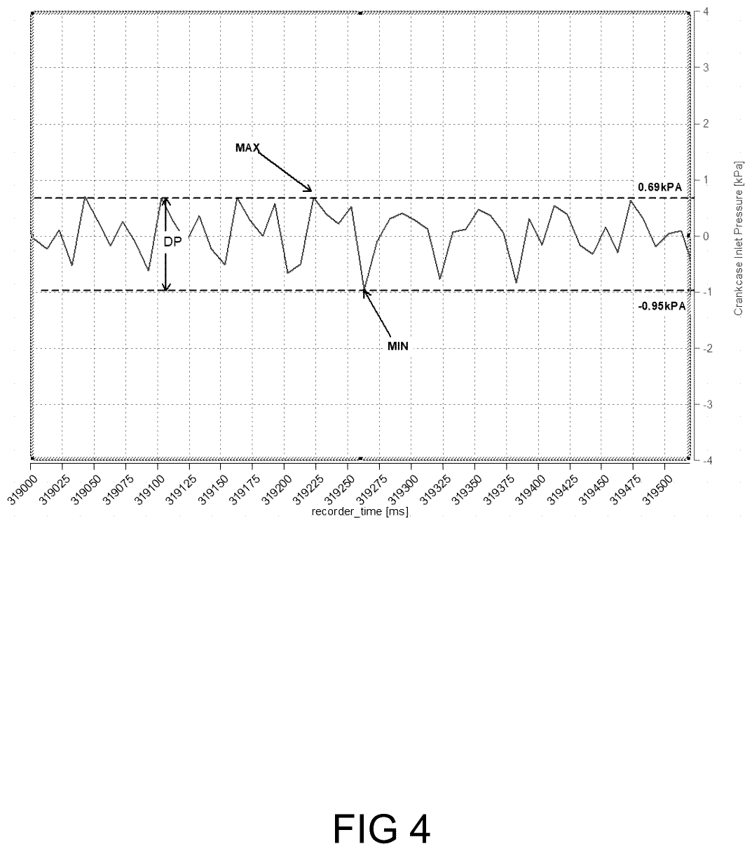

An example of a received pressure measurement signal P is provided in FIGS. 3 and 4. FIG. 3 illustrates an exemplary pressure measurement signal for an intact first section of the blow-by line between the crankcase and the crankcase depression regulator, i.e. without leaks. In contrast, FIG. 4 illustrates what the pressure measurement signal in the same first section could look like in case there is a leakage in the blow-by line, in particular a leakage of 10 mm. Comparing FIGS. 3 and 4 it is clear that the difference between the absolute maximum MAX and minimum MIN pressure, i.e. the delta pressure DP, is lower in the leaky blow-by line. In other words, in the leaky blow-by line of FIG. 4 the amplitude of oscillations is reduced with respect to the healthy blow-by line of FIG. 3. Also, the average pressure in the leaky blow-by line is higher than in the intact blow-by line. Hence, by comparing these values to respective calibratable thresholds, an indication of a healthy (e.g. non-leaking) or a defective (e.g. leaking) CCV can be obtained.

The alert signal generated by the control unit 150 in response to detecting a leakage in the blow-by line can comprise a control signal that triggers further action by the controller 150 and/or the engine 10, e.g. switching the engine or the CCV system to a safe mode. Additionally, or alternatively, the alert signal can comprise an audio or visual warning to a user, e.g. that service is needed or that (manual) action is required.

Optionally, the control unit 150 may comprise a signal processor 151 arranged for processing the pressure measurement signal P received from the pressure sensor 131, and for determining a health status of the pressure sensor 131 by comparing a voltage, current, frequency and/or continuity of the pressure measurement signal P relative to a reference. In case the control unit 150 determines that there is a substantial difference between the measured voltage, current, frequency and/or continuity of the signal P and reference, this could be indicative of a sensor failure or a communication error. Accordingly, the control unit 150 may abort the diagnostic test since the results of the test may not be reliable due to the faulty input data.

Additionally, or alternatively, the control unit 150 may be arranged for preventing that the diagnostic test is even started when engine or CCV system conditions are unreliable. For example, the control unit 150 may be arranged for starting the diagnostic time period only in response to determining that one or more enable conditions are met. For example, that a filter module in the blow-by line is present and active. The presence and correct functioning of a filter module can substantially influence the pressure in the blow-by line, and therefore affect the outcome of the diagnostic test. Another or further enable condition may be that an ambient temperature is larger than an ambient temperature threshold value. For example, in cold temperatures the outcome of the test may not be accurate. Yet another or further enable condition may be that an engine coolant temperature is larger than an engine coolant temperature threshold value, or that an engine running time is larger than an engine running time threshold value. This ensures that the engine has reached a “steady state”, with relatively invariant operating conditions. At least one of these or other enable conditions are preferably met to ensure that the outcome of the diagnostic test is accurate and reliable.

In the embodiment illustrated in FIG. 1, the CCV system 100 comprises a single pressure sensor 131 provided in a first section 101 of the blow-by line, between the crankcase 14 and the crankcase depression regulator 110. Pressure sensor 131 is thus arranged for measuring the pressure in the first section 101 relative to atmospheric pressure, and the control unit 150 monitors the first section 101 for leakages, based on the pressure measurement signal from the pressure sensor 131 in the first section 101.

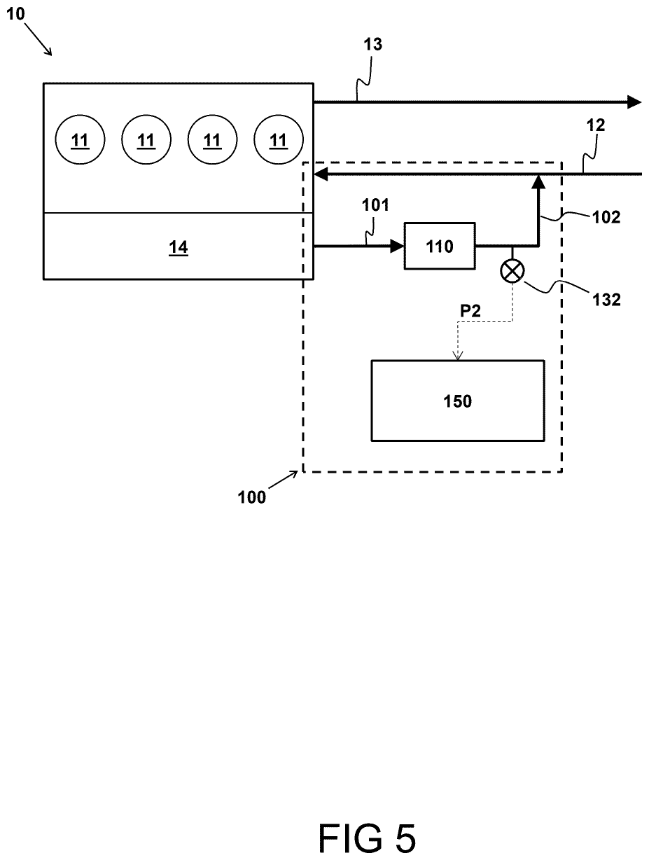

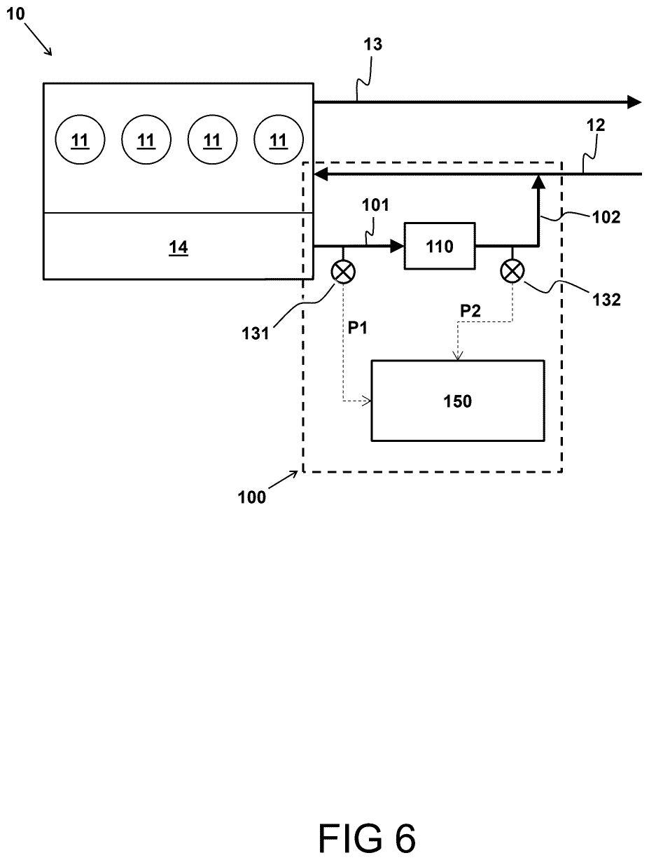

Optionally, as illustrated in FIG. 5, a second pressure sensor 132 can be provided in a second section 102 of the blow-by line, e.g. between the crankcase depression regulator 110 and the intake line 12. The second pressure sensor can be used instead of, or in addition to, the first pressure sensor in the first section 101 of the blow-by line. Hence, in some embodiments, a first and second pressure sensor may be simultaneously present, e.g. as illustrated in FIG. 6. Nonetheless, the diagnostic test only makes use of the pressure measurement signal from either the first or second pressure sensor.

The second pressure sensor 132 may thus be arranged for measuring a second pressure P2 in the second section 102 relative to atmospheric pressure. Accordingly, the control unit 150 is arranged for additionally or alternatively performing a second diagnostic test based on the second pressure measurement signal from the second pressure sensor 132, to detect leakages in the second section 102.

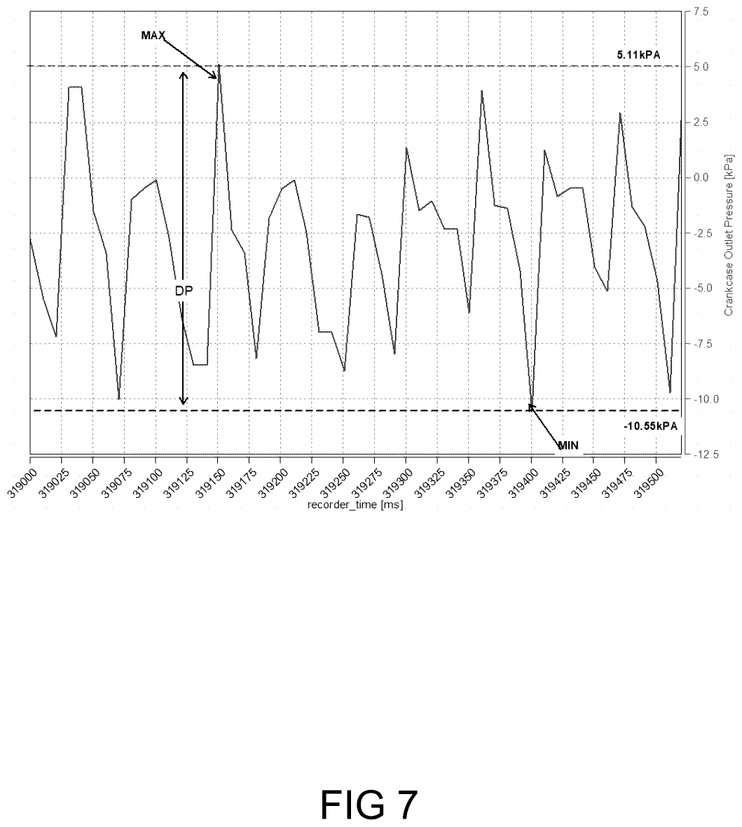

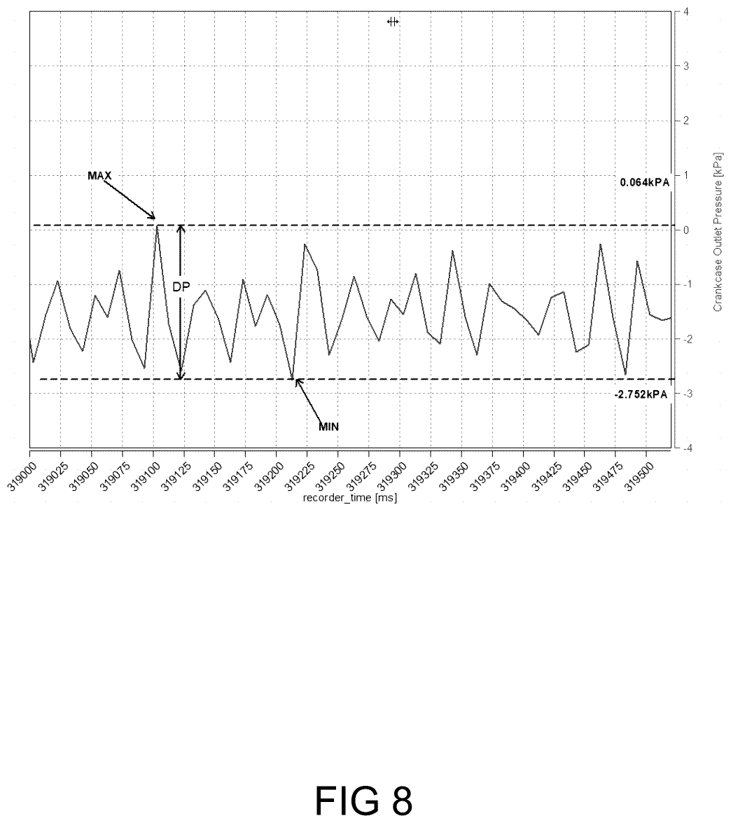

FIGS. 7 and 8 illustrate exemplary graphs of a pressure measurement signal that may be obtained from the second pressure sensor in the second section of the blow-by line between the crankcase depression regulator and the intake line, in a healthy and leaking condition, respectively. Similar to FIGS. 3 and 4, it can be seen in FIGS. 7 and 8 that the difference between the absolute maximum MAX and minimum MIN pressure, i.e. the delta pressure DP, is lower in the leaky blow-by line, and that the average pressure in the leaky blow-by line is higher than in the intact blow-by line.

In accordance with the present invention, the second diagnostic test of the second section 102 is performed independently from the first diagnostic test of the first section 101. In other words, the first diagnostic test only uses the first pressure measurement signal from the first pressure sensor 131, and the second diagnostic test only uses the second pressure measurement signal P2 from the second pressure sensor 132. Apart from using different input signals P1, P2, the other steps of the first and second diagnostic tests are the same, i.e. the steps of calculating the delta pressure and the average pressure, and comparing these calculated values with the first and second threshold, respectively, in order to determine whether a leakage is present in the first or second section.

Notwithstanding, the diagnostic time period and the first and second thresholds may be different in the first and second diagnostic test, e.g. because the normal working pressure in the second section 102 is not the same as in the first section 101, or because the second section 102 has a different length than the first section 101.

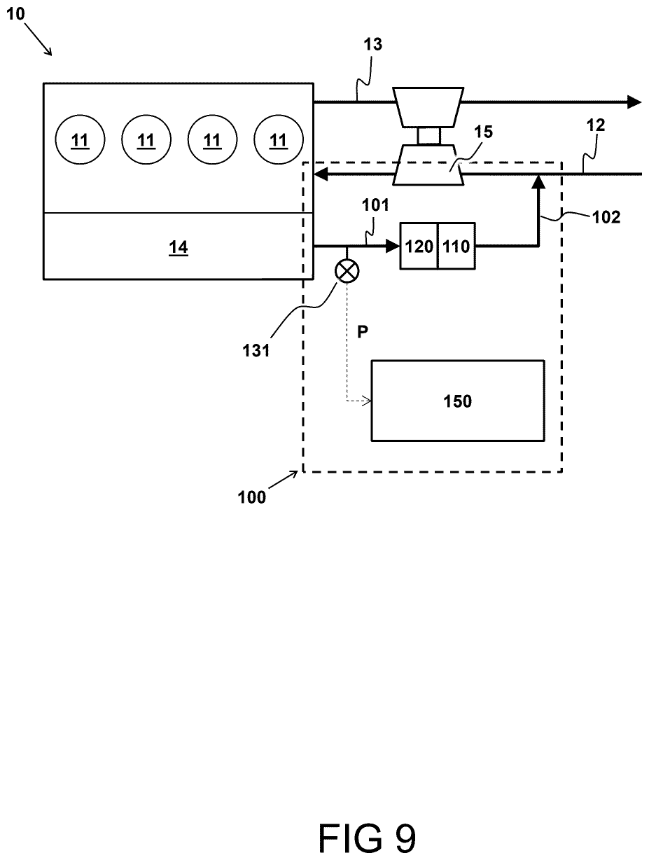

As illustrated in FIG. 9, the CCV system 100 may further comprise a filter module 120 provided in the blow-by line 101, 102. Preferably, in use, blow-by gases are transported from the crankcase 14 and fed into the filter module 120, e.g. a rotating crankcase ventilator (RCV). The filter module 120 or RCV is arranged for filtering out oil particles from the blow-by gas. Subsequently, filtered gas travels through the crankcase depression regulator (CDR) 110 and fed into the engine air intake line 12, e.g. upstream the turbo compressor 15. The CDR is arranged for regulating the crankcase pressure within safe boundaries, e.g. by modulating an internal valve mechanism.

The filter module 120 may comprise any type of filter suitable for filtering blow-by gases, such as a low or high grade coalescing filter, e.g. motor assisted, or a basic breather. In some variants, the filter module 120 comprises a rotating crankcase ventilator, RCV. The control unit 150 may be arranged for controlling a rotation speed of the rotating crankcase ventilator based on the pressure measurement signal P.

As illustrated in FIG. 9, the internal combustion engine may further comprise a turbo compressor 15 in the air intake line 12 for pressurizing intake air. The turbo compressor 15 may be coupled to a turbine in the exhaust line 13. Preferably, the blow-by line 101, 102 connects to the air intake line 12 upstream the compressor 15, i.e. on the low pressure side of the compressor, such that blow-by gas enters the air intake line before passing through the compressor 15.

It will be clear to the skilled person that the invention is not limited to any specific embodiment herein described and that combinations or modifications are possible, in as far as these can be considered within the scope of the appended claims. Also kinematic inversions are considered inherent to the invention disclosed herein. In the claims, any reference signs shall not be construed as limiting the claim.

The terms ‘comprising’ and ‘including’ when used in this description or the appended claims should not be construed in an exclusive or exhaustive sense but rather in an inclusive sense. Thus expression as ‘including’ or ‘comprising’ as used herein does not exclude the presence of other elements, additional structure or additional acts or steps in addition to those listed. Furthermore, the words ‘a’ and ‘an’ shall not be construed as limited to ‘only one’, but instead are used to mean ‘at least one’, and do not exclude a plurality. Features that are not specifically or explicitly described or claimed may additionally be included in the structure of the invention without departing from its scope.

Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. To the extent that structure, material, or acts are considered to be essential they are inexpressively indicated as such. Additions, deletions, and modifications within the purview of the skilled person may generally be made without departing from the scope of the invention, as determined by the claims.

1. A closed crankcase ventilation system for removing blow-by gases, leaking from a combustion chamber, from a crankcase of an internal combustion engine, the system comprising:
a blow-by line, extending between the crankcase and an air intake line of the internal combustion engine, wherein, when the internal combustion engine is running, the air intake line provides a vacuum source for drawing blow-by gases from the crankcase through the blow-by line;
a crankcase depression regulator, arranged in the blow-by line for regulating a level of vacuum inside the crankcase;
one or more pressure sensors, each arranged for measuring a pressure in the blow-by line relative to atmospheric pressure;
a control unit, arranged for detecting leakages in the blow-by line by performing a diagnostic test by:
receiving, within a diagnostic time period, a pressure measurement signal from each of the one or more pressure sensors;
calculating, for each received pressure measurement signal, a difference between an absolute maximum and an absolute minimum of the received pressure measurement signal to define a delta pressure;
calculating, for each received pressure measurement signal, an average pressure of the received pressure measurement signal over the diagnostic time period;
generating an alert signal indicative of a leakage in the blow-by line in response to determining, that for at least one of the received pressure measurement signals, the following conditions are both true:
the delta pressure is lower than a first threshold value; and
the average pressure is higher than a second threshold value.

2. The closed crankcase ventilation system according to claim 1, wherein the at least one pressure sensor comprises a first pressure sensor,
wherein the pressure sensor is provided in a first section of the blow-by line between the crankcase and the crankcase depression regulator and arranged for measuring a first pressure in the first section relative to atmospheric pressure, and
wherein the control unit is arranged for performing the diagnostic test by receiving the pressure measurement signal from the first pressure sensor.

3. The closed crankcase ventilation system according to claim 1, wherein the at least one pressure sensor comprises a second pressure sensor,
wherein the second pressure sensor is provided in a second section of the blow-by line between the crankcase depression regulator and the intake line and arranged for measuring a second pressure in the second section relative to atmospheric pressure, and
wherein the control unit is arranged for performing the diagnostic test by receiving the pressure measurement signal from the second pressure sensor.

4. The closed crankcase ventilation system according to claim 1, wherein the control unit is arranged for calculating the first threshold and/or the second threshold as function of engine speed and engine torque of the internal combustion engine.

5. The closed crankcase ventilation system according to claim 1, wherein the control unit comprises a signal processor arranged for processing the pressure measurement signal received from the at least one pressure sensor, and
wherein the signal processor is arranged for determining a health status of the at least one pressure sensor by comparing a voltage, current, frequency and/or continuity of the pressure measurement signal relative to a reference.

6. The closed crankcase ventilation system according to claim 5, wherein the control unit is arranged for aborting the diagnostic test in response to determining that the health status indicates a sensor failure.

7. The closed crankcase ventilation system according to claim 1, wherein the control unit is arranged for starting the diagnostic time period in response to determining that one or more of the following enable conditions are met:
a filter module in the blow-by line is active;
an ambient temperature is larger than an ambient temperature threshold value;
an engine coolant temperature is larger than an engine coolant temperature threshold value;
an engine running time is larger than an engine running time threshold value.

8. The closed crankcase ventilation system according to claim 1, wherein the diagnostic time period is between 10 and 120 seconds.

9. The closed crankcase ventilation system according to claim 1, further comprising a filter module provided in the blow-by line and arranged for filtering blow-by gas that passes through the filter module.

10. The closed crankcase ventilation system according claim 9, wherein the filter module comprises a rotating crankcase ventilator.

11. The closed crankcase ventilation system according to claim 10, wherein the control unit is arranged for controlling a rotation speed of the rotating crankcase ventilator based on the pressure measurement signal.

12. The closed crankcase ventilation system according to claim 1, wherein the crankcase depression regulator comprises a valve mechanism for opening and closing a passage for blow-by gases through the blow-by line, and
wherein the crankcase depression regulator comprises a valve actuator for actuating the valve mechanism;
wherein the control unit is further arranged for controlling the valve actuator based on the pressure measurement signal.

13. An internal combustion engine comprising a closed crankcase ventilation system according to claim 1.

14. The internal combustion engine according to claim 13, further comprising a turbo compressor arranged in the intake line for pressurizing intake air,
wherein the blow-by line connects to the intake line upstream the compressor.

15. The internal combustion engine according to claim 13, wherein the intake line comprises a vacuum pump that provides the vacuum source.

16. The closed crankcase ventilation system according to claim 2, wherein the at least one pressure sensor comprises a second pressure sensor,
wherein the second pressure sensor is provided in a second section of the blow-by line between the crankcase depression regulator and the intake line and arranged for measuring a second pressure in the second section relative to atmospheric pressure, and
wherein the control unit is arranged for performing the diagnostic test by receiving the pressure measurement signal from the second pressure sensor.
